(19) United States
(12) Patent Application Publication
(10) Pub. No.: US 2026/0329212 A1
(43) Pub. Date: Oct. 22, 2026

(54) PRINTING SYSTEM, CONTROL METHOD THEREFOR, AND STORAGE MEDIUM

(71) Applicant: CANON KABUSHIKI KAISHA, Tokyo (JP)

(72) Inventor: RYOSUKE YAMAZAKI, Saitama (JP)

(21) Appl. No.: 19/645,002

(22) Filed: Apr. 10, 2026

(30) Foreign Application Priority Data
Apr. 22, 2025 (JP) 2025-070476

(51) Int. Cl. G03G 15/00

(52) U.S. Cl. CPC G03G 15/502; G03G 15/5066; G03G 15/55; G03G 15/6588

(57) ABSTRACT

A printing system includes a charge removal apparatus, at least one memory that stores instructions, and a processor that causes, by performing the stored instructions, the printing system to set a first setting value of a first amount of charge removal for a sheet in a storage that stores a setting value of an amount of charge removal for each sheet type, obtain a second setting value of a second amount of charge removal set via an operation unit of the charge removal apparatus, and notify a user of information that prompts the user to check a charge removal setting set via the operation unit, in a case where, when the first amount of charge removal is set, the first setting value of the first amount of charge removal is different from the second setting value of the second amount of charge removal.

### BACKGROUND

### Field of the Technology

The present disclosure relates to a printing system having a charge removal function to remove charge from a charged sheet, a control method therefor, and a storage medium.

### Description of the Related Art

A recording medium (hereinafter, referred to as a “sheet”) used in a print operation is conveyed charged with static electricity due to residual charge generated in an electrophotographic process or slight friction with conveyance rollers or guides during the conveyance of the sheet. This static electricity may cause sheets to stick to each other.

Plain paper or similar types of paper have low electrical resistance in the sheet itself, allowing charge to move easily within the sheet. The amount of charge is low, and the charge dissipates quickly. In contrast, other types of sheets, such as thick paper, synthetic paper, and coated paper, in which a synthetic resin (plastic) is used, have high electrical resistance in the sheet itself, and thus charge does not easily move within the sheet. As a result, these types of sheets, such as synthetic paper and coated paper, are more easily charged, and the charge tends to remain. Further, it is generally known that these types of sheets are susceptible to the environment, in particular, humidity, and are apt to be charged with static electricity because of a lower amount of discharge in environments with lower humidity.

If post-processing were performed on sheets sticking to each other, the sticking sheets would be likely to affect sheet alignment processing, not only degrading the quality of the post-processing, but causing a paper jam due to sheet-feed failure or conveyance failure during the post-processing.

For this reason, in order to avoid the issue, it is desirable to remove static electricity from the sheet subjected to printing processing before the post-processing is performed. Thus, a technique is described of neutralizing electric charge on a sheet by applying a voltage to a pair of conveyance rollers disposed downstream in the sheet conveyance direction to cancel out the charge on the sheet (refer to Japanese Patent Laid-Open No. 1999-258881).

As described above, the charge removal configuration including applying a voltage to a conventional conveyance roller (hereinafter, referred to as a “charge removal roller”) neutralizes charged static electricity by applying charge with a polarity opposite to that of the charge on the sheets to the sheets via the charge removal roller. Thus, settings for the amount of charge removal using the charge removal roller (the application of charge with polarity opposite to the charge on the sheet to the charge removal roller) need to be configured based on the amount of charge on the sheet. Thus, this means that an optimal charge adjustment value for charge removal exists for each printing environment, such as humidity, and each type of sheet.

Further, if a user starts printing without checking the charge adjustment value for charge removal, there is a possibility that charge removal control is performed on the sheets with an inappropriate charge adjustment value set. In this case, conversely, the sheets are charged, which may result in high likelihood of sticking sheets.

A configuration in which the optimal charge adjustment value for charge removal can be adjusted using hardware allows the user to directly adjust the optimal charge adjustment value while checking the adjustment results, facilitating the adjustment. However, it is difficult to provide a hardware adjustment function that supports a plurality of types of sheets in terms of operability, and thus the adjustment is assumed to be for a single type of sheet. On the other hand, a configuration allowing adjustment using software makes it possible to provide an adjustment function that supports a plurality of types of sheets. However, the configuration causes time consumption in frequent adjustment for some types of sheets, such as plain paper, which are susceptible to environmental influence. It is desirable to compatibly use these two configurations with good usability.

### SUMMARY

According to an aspect of the present disclosure, a printing system includes a charge removal apparatus, at least one memory that stores instructions, and at least one processor that causes, by performing the stored instructions, the printing system to set a first setting value of a first amount of charge removal for a sheet in a storage unit configured to store a setting value of an amount of charge removal for each sheet type, obtain a second setting value of a second amount of charge removal set via an operation unit of the charge removal apparatus, and notify a user of information that prompts the user to check a charge removal setting set via the operation unit, in a case where, when the first amount of charge removal is set in the storage unit, the first setting value of the first amount of charge removal is different from the second setting value of the second amount of charge removal.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an entire configuration of a system according to a first embodiment.

FIG. 2 is a block diagram illustrating a hardware configuration of a printing system according to the first embodiment.

FIG. 3 is a cross-sectional view of the printing system according to the first embodiment.

FIG. 4 is a diagram illustrating an operation unit of a printing device of the printing system according to the first embodiment.

FIG. 5 is a diagram illustrating an operation unit of a charge removal apparatus included in the printing system according to the first embodiment.

FIG. 6 is a schematic diagram illustrating charge removal processing performed by the charge removal apparatus according to the first embodiment.

FIGS. 7A and 7B illustrate a sheet database reference screen and a change screen via a sheet data management unit, respectively.

FIG. 8 is a flowchart of printing processing according to the first embodiment.

FIG. 9 illustrates an adjustment dial check screen according to the first embodiment.

FIG. 10 is a flowchart of processing of prompting a user to check a setting value for a charge removal apparatus according to a second embodiment.

FIG. 11 illustrates an adjustment dial check screen according to the second embodiment.

### DESCRIPTION OF THE EMBODIMENTS

Some example embodiments will now be described with reference to the drawings.

The following embodiments are not intended to limit every embodiment, and not all of the combinations of features described in the following embodiments are necessarily essential to the solutions provided by the disclosure.

### First Embodiment

### Entire Configuration of System

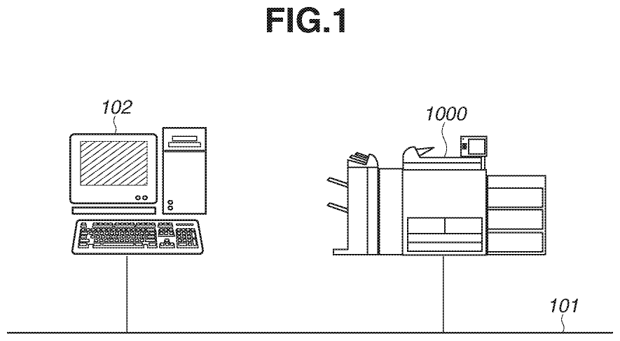

FIG. 1 is a diagram illustrating an entire configuration of a system in a first embodiment.

The system of the first embodiment includes a printing system 1000 and a personal computer (PC) 102, which is a client computer. The printing system 1000 and the PC 102 are connected to each other via a network 101.

The PC 102 is capable of transmitting code data (in a page description language (PDL)) as a print job to the printing system 1000 via the network 101.

### Hardware Configuration of Printing System

### Printing System

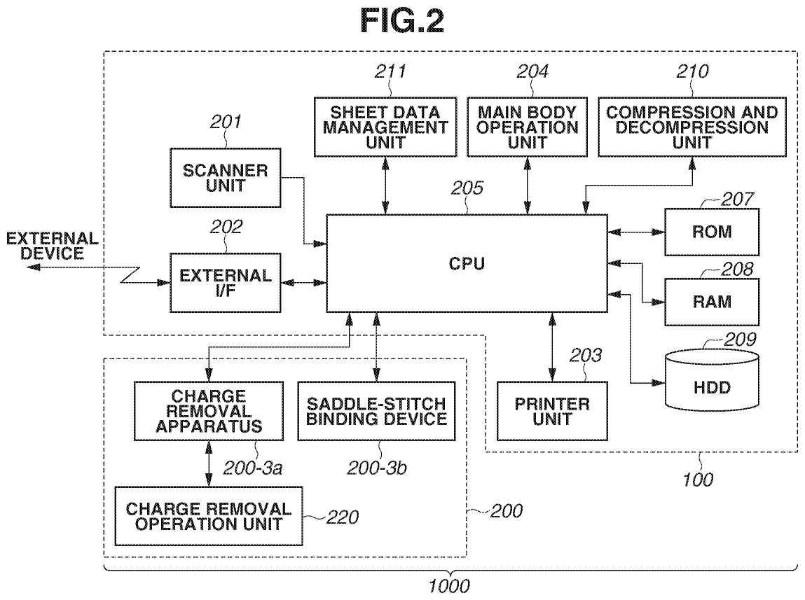

FIG. 2 is a block diagram illustrating a hardware configuration of the printing system 1000.

The printing system 1000 includes a printing device 100, and a sheet processing device 200, each of which is represented by a section enclosed by dotted lines in FIG. 2. Further, any desired number of the sheet processing devices 200 can be connected to the printing device 100. In the present embodiment, an example will be described in which the sheet processing device 200 includes a charge removal apparatus 200-3a and a saddle-stitch binding device 200-3b. Further, in the present embodiment, an example will be described of, as the printing device 100, a multi-function peripheral (MFP) having a plurality of functions, such as a copy function and a printer function. However, the printing device 100 may be a single-function printing device having only a copy function or only a printer function. In the present embodiment, as an example, the printing system 1000 is assumed to include various constituents described in the following.

The printing system 1000 is configured to perform sheet processing on sheets printed by the printing device 100 using the sheet processing device 200 connected to the printing device 100. However, the printing system 1000 can be configured only using the printing device 100 without connecting the sheet processing device 200 to the printing device 100.

The charge removal apparatus 200-3a is configured to be communicable with the printing device 100, and is capable of receiving instructions from the printing device 100 to perform charge removal processing described below.

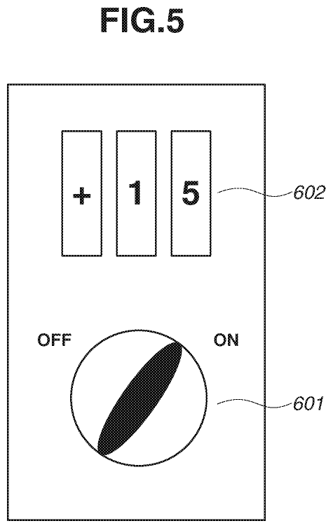

A charge removal operation unit 220 has a configuration as illustrated in FIG. 5 described below, and the user can configure settings for the charge removal apparatus 200-3a via the charge removal operation unit 220.

The user may be allowed to configure settings for the charge removal apparatus 200-3a via a main body operation unit 204 described below.

The saddle-stitch binding device 200-3b is configured to be communicable with the printing device 100, and is capable of receiving instructions from the printing device 100 to perform sheet processing described below.

### Printing Device

A scanner unit 201 reads an image on a document, converts the read image into image data, and transmits the converted image data to another unit.

An external interface (I/F) 202 transmits and receives data to and from an external device connected to the network 101.

A printer unit 203 prints on a sheet an image based on input image data.

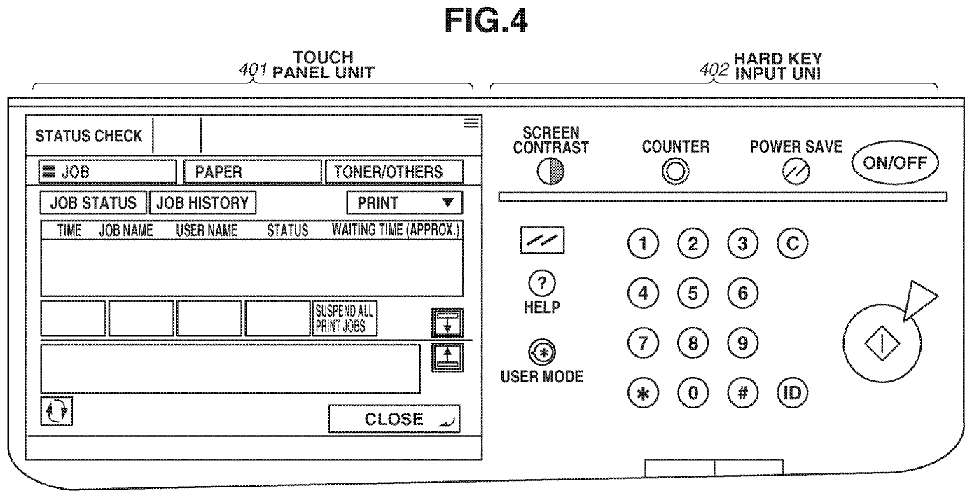

As illustrated in FIG. 4, the main body operation unit 204 includes a touch panel unit 401 and a hard key input unit 402 to receive instructions from the user via the touch panel unit 401 and the hard key input unit 402. Further, the main body operation unit 204 displays various types of information on the touch panel unit 401.

A central processing unit (CPU) 205 generally controls the processing, the operation, and the like of each unit included in the printing system 1000. In other words, the CPU 205 also controls the operation of the printing device 100 and the operation of the sheet processing device 200 connected to the printing device 100.

A read only memory (ROM) 207 stores various types of computer programs to be executed by the CPU 205.

For example, the ROM 207 stores programs for causing the CPU 205 to execute various types of processing of flowcharts described below, or a display control program for displaying various setting screens described below. The ROM 207 stores a program for causing the CPU 205 to interpret PDL code data received from the PC 102 to convert the data into raster image data.

Further, the ROM 207 stores a boot sequence, font information, and the like.

A random access memory (RAM) 208 stores image data and PDL code data transmitted from the scanner unit 201 or the external I/F 202, various types of programs loaded from the ROM 207, and setting information. Further, the RAM 208 stores information regarding the sheet processing device 200 (for example, information regarding the type or the function of each sheet processing device 200 connected to the printing device 100). The CPU 205 can use information regarding the sheet processing device 200 stored in the RAM 208 for control.

A hard disk drive (HDD) 209 includes a hard disk and a drive unit for reading and writing data from and to the hard disk. The HDD 209 is a large-capacity storage device for storing image data, which is input from the scanner unit 201 and is compressed by a compression and decompression unit 210. The CPU 205 can cause the printer unit 203 to print image data stored in the HDD 209 based on the user's instructions. The HDD 209 is also used as a spooler, and the CPU 205 can manage PDL code data received from the PC 102 as print jobs and store the data in the HDD 209. Further, the CPU 205 can manage print jobs stored in the HDD 209 and obtain the number of print jobs stored and setting information set for each of the print jobs. Alternatively, instead of or in addition to the HDD, another storage device, such as a solid state drive (SSD) or embedded multi-media card (eMMC) may be included.

The compression and decompression unit 210 compresses and decompresses image data and the like stored in the RAM 208 and the HDD 209 using various types of compression methods, such as Joint Bi-level Image Experts Group (JBIG) and Joint Photographic Experts Group (JPEG).

A sheet data management unit 211 manages information about control parameters used at the time of printing sheets, priority information about charge removal control parameters, and information about environmental change influence for the type of each sheet and for the product name of each sheet. Examples of control parameters include information, such as a sheet grammage, a surface property, a voltage adjustment value for transfer, and a charge removal bias adjustment value for charge removal control. Further, while the sheet data management unit 211 is illustrated in this manner as a part of the block diagram, the sheet data management unit 211 is actually a database in which a sheet information table is stored, and the database itself is stored in the HDD 209.

In the sheet information table (not illustrated), sheet names, such as “plain paper”, “synthetic paper”, and “thick paper”, are stored in the column for names, grammages representing sheet thicknesses are stored in the column for grammages, and sheet sizes are stored in the column for sizes. Further, information regarding sheet surface properties, such as “fine-quality paper” and “polypropylene”, is stored in the column for surface property, information regarding characteristics of the sheets is stored in the column for characteristics, and magnitudes of variation in the amount of charge when the environment varies are stored in the column for environmental change influence. Further, parameter information necessary for adjustment, such as specific adjustment values, is stored in the column for charge removal bias adjustment.

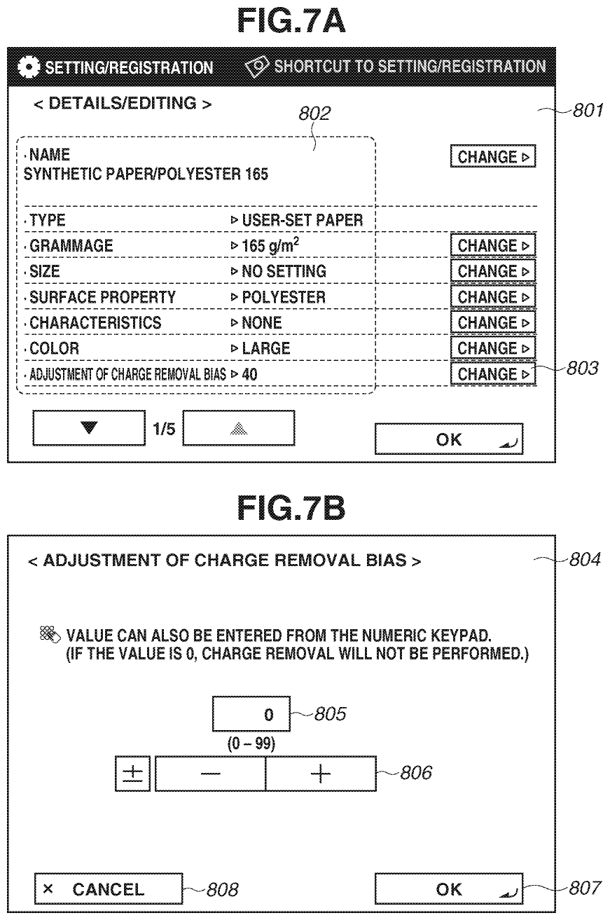

The sheet data management unit 211 includes a dedicated screen for referring to and editing the content of the sheet information table. FIGS. 7A and 7B each illustrate examples of the dedicated screen. The printing system 1000 is configured so that the user can call a setting screen for each sheet via the main body operation unit 204. Then, in response to receiving the call, the CPU 205 displays a parameter list screen 801 for a sheet illustrated in FIG. 7A on the touch panel unit 401 of the main body operation unit 204.

### Parameter List Screen

The parameter list screen 801 includes a field 802 for displaying parameters and current setting values of the parameters, and each parameter is provided with a change button 803 to be pressed when the setting value is changed. For example, when the user presses the change button 803 to change the parameter of the charge removal bias adjustment, the CPU 205 displays a charge removal bias adjustment screen 804 illustrated in FIG. 7B on the touch panel unit 401 of the main body operation unit 204. The CPU 205 then obtains information about the sheet type for each sheet feed tray used in printing to obtain parameter information about charge removal control set for the sheet via the sheet data management unit 211. Out of the information, the adjustment value of charge removal bias is obtained as information regarding the charge removal bias adjustment and is saved in the RAM 208.

### Screen for Adjusting Charge Removal Bias

The charge removal bias adjustment screen 804 includes a field for displaying a current charge removal bias adjustment value 805, input buttons 806 for increasing or decreasing the setting value, and an OK button 807 for saving the input setting value in a storage area, such as the RAM 208. Further, the charge removal bias adjustment screen 804 includes a cancel button 808 for exiting the charge removal bias adjustment screen 804 without saving the charge removal bias adjustment value 805 in the storage area, such as the RAM 208. As the charge removal bias adjustment value 805, the charge removal bias adjustment value stored in the RAM 208 by the CPU 205 is displayed on the charge removal bias adjustment screen 804 illustrated in FIG. 7B.

Then, a bias voltage for charge removal processing to be performed on the sheet by the charge removal apparatus 200-3a, which will be described below, can be set. In the present embodiment, a bias voltage for charge removal processing in this case is not set at an actual voltage value in kilovolt (kV) but at an intensity level within the range of 0 to 99. In actual operation, for example, a voltage of 0.1 (kV) is applied to a charge removal roller for each increment of 1. The units of the setting value and the settable range described above are merely examples, and are not limited thereto.

As another example of the parameters, in the item for environmental change influence, the environmental change influence mainly related to humidity can be set in consideration of a moisture content of the sheet. The setting values described herein are stored in the HDD 209 via the sheet data management unit 211.

The CPU 205 is configured to access the sheet information table via the sheet data management unit 211 to acquire characteristic information about the sheet used in printing and parameter information used for print control.

Although details will be described below, the printing system 1000 of the present embodiment includes a charge removal apparatus capable of configuring settings for its charge removal function.

### Configuration Details of Printing System

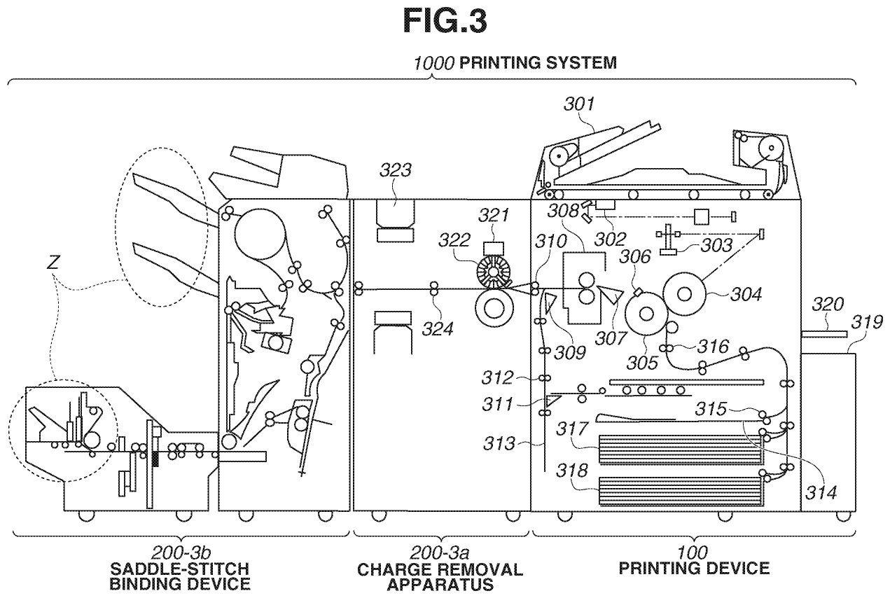

FIG. 3 is a cross-sectional view of the printing device 100 and the sheet processing device 200 connected to the printing device 100.

The sheet processing device 200 of the present embodiment includes the charge removal apparatus 200-3a and the saddle-stitch binding device 200-3b.

### Printing Device

The printing device 100 will now be described.

An automatic document feeder (ADF) 301 sequentially separates a bundle of sheets of a document placed on the document placement surface of a document tray from the first page in the page order to convey the sheets one by one onto a platen glass to be scanned by a scanner 302.

The scanner 302 reads images of the document conveyed onto the platen glass to convert the read image into image data using a charge-coupled device (CCD) sensor.

A rotating polygon mirror 303 receives a light beam, for example, a laser beam modulated based on the image data to irradiate a photosensitive drum 304 with the laser beam as reflected scanning light via a reflecting mirror.

A latent image formed on the photosensitive drum 304 by the laser beam is developed with toner, and the toner image is transferred to a sheet material held on a transfer drum 305. A series of image formation processes is sequentially performed for yellow (Y), magenta (M), cyan (C), and black (K) toners to form a full-color image. After the four image formation processes, the sheet material with the full-color image formed thereon on the transfer drum 305 is separated from the transfer drum 305 by a separation pawl 306 to be conveyed to a fixing device 308 by a pre-fixing conveyancer 307.

The fixing device 308, which is provided with a combination of rollers and a belt, contains a heat source, such as a halogen heater, and melts and fixes the toner as the transferred toner image on the sheet material using heat and pressure.

A sheet ejection flapper 309, which is configured to be swingable around a swing shaft, controls the conveyance direction of the sheet material. When the sheet ejection flapper 309 pivots in the clockwise direction in FIG. 3, the sheet material is conveyed straight and discharged to the outside of the printing device 100 by ejection rollers 310.

The CPU 205 controls the printing device 100 to perform one-sided printing through the series of sequences described above.

### Two-Sided Printing

On the other hand, to form images on both sides of a sheet material, the sheet ejection flapper 309 pivots in the counterclockwise direction in FIG. 3, and the conveyance direction of the sheet material is changed downward to be conveyed to a two-sided conveyance unit. The two-sided conveyance unit includes a reversing flapper 311, reversing rollers 312, a reversing guide 313, and a two-sided tray 314.

The reversing flapper 311 swings around a swing shaft to control the conveyance direction of the sheet material. To process a two-sided printing job, the CPU 205 controls the reversing flapper 311 to pivot in the counterclockwise direction in FIG. 3 to convey the sheet with a first surface of the sheet subjected to printing by the printer unit 203 to the reversing guide 313 via the reversing rollers 312. Then, the CPU 205 once stops the reversing rollers 312 with the trailing edge of the sheet material nipped between the reversing rollers 312, and then pivots the reversing flapper 311 in the clockwise direction in FIG. 3. The CPU 205 also rotates the reversing rollers 312 in the opposite direction. Through this operation, the CPU 205 controls the sheet to be conveyed in a switchback manner to be guided to the two-sided tray 314 with the trailing and leading edges of the sheet reversed.

The sheet material is once placed on the two-sided tray 314, and then is conveyed to registration rollers 316 again by re-feed rollers 315. In this case, the sheet material is being conveyed with the surface (a second sheet surface) opposite to the first surface subjected to the transfer processing facing the photosensitive drum 304. Then, as in the process described above, an image for the second sheet surface is formed on the second sheet surface. The images are formed on both the surfaces of the sheet material, and the sheet goes through the fixing processing and then is discharged to the outside of the main body of the printing device 100 via the ejection rollers 310.

The CPU 205 controls the printing device 100 to perform two-sided printing through the series of sequences described above. Further, the control processing for performing two-sided printing described above is merely an example, and is not limited thereto.

Further, the printing device 100 includes sheet feed units that store sheets for printing processing. The sheet feed units are sheet feed cassettes 317 and 318 (e.g., each of the cassettes has a capacity of 500 sheets), a sheet feed deck 319 (e.g., the deck has a capacity of 5,000 sheets), a manual feed tray 320, and another similar type of unit. Sheets of various sizes and materials can be loaded in the sheet feed cassettes 317, 318 and the sheet feed deck 319 separately for each sheet feed unit. Further, various types of sheets including special sheets, such as overhead projector (OHP) sheets, can be placed on the manual feed tray 320.

### Charge Removal Apparatus

The charge removal apparatus 200-3a will now be described.

FIG. 5 is a diagram illustrating the charge removal operation unit 220 of the charge removal apparatus 200-3a.

A mode setting switch 601 illustrated in FIG. 5 switches between execution and non-execution of charge removal by the charge removal apparatus 200-3a (ON and OFF), and the CPU 205 controls the charge removal processing described below to be performed only with the switch set to ON.

An adjustment dial 602 as a thumb rotary switch is used to adjust the intensity of the charge removal control that is performed with the mode setting switch 601 set to ON. The adjustment dial 602 is controlled by the CPU 205 to be enabled only with the mode setting switch 601 set to ON. The amount of charge removal, which represents an intensity of the charge removal control set by the adjustment dial 602, can be adjusted in the same unit as that of the adjustment value of the charge removal bias set by the current charge removal bias adjustment value 805 on the charge removal bias adjustment screen 804 described above.

### Charge Removal Processing

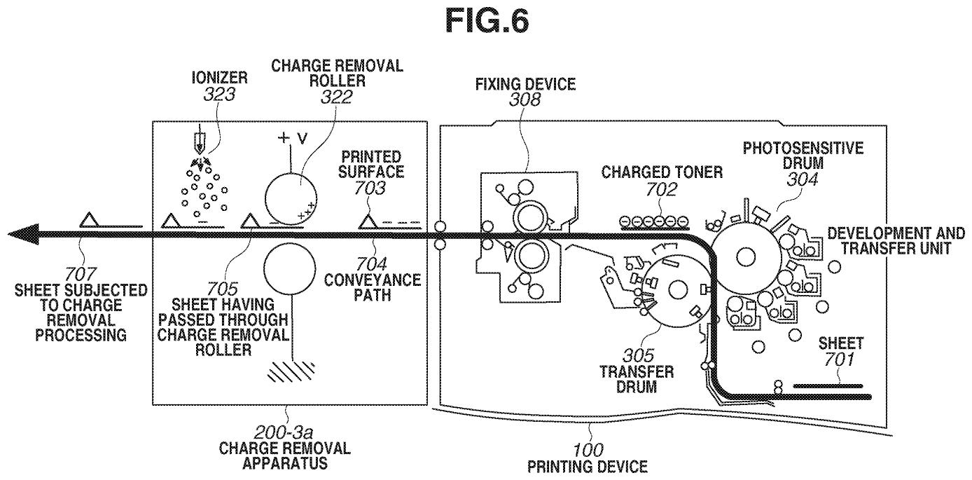

The charge removal processing performed by the charge removal apparatus 200-3a will now be described with reference to FIG. 6.

FIG. 6 is a schematic diagram illustrating a state in which the charge removal processing is performed by the charge removal apparatus 200-3a on a sheet subjected to printing processing by the printing device 100.

First, a sheet 701 is conveyed on a conveyance path 704 to a development and transfer unit including the photosensitive drum 304 and the transfer drum 305, and a toner image is transferred to the sheet 701. Charged toner 702 on the sheet 701 is negatively charged, and the sheet with the toner image fixed thereto by the fixing device 308 is conveyed to the charge removal apparatus 200-3a in a state where toner on a printed surface 703 of the sheet 701 is negatively charged.

The charge removal apparatus 200-3a includes a charge removal roller 322, which is being positively charged, and the charge removal roller 322 applies positive charge to the negatively charged printed surface 703 in contact with the charge removal roller 322 to neutralize the charged state. However, it is conceivable that negative charge that has not been completely removed through the charge removal processing by the charge removal roller 322, or positive charge opposite in polarity to the charge on the sheet could remain on a sheet 705 that has passed through the charge removal roller 322. Thus, the charge removal apparatus 200-3a described in the present embodiment is configured to further include an ionizer 323 downstream of the charge removal roller 322. The ionizer 323 applies a voltage to an electrode needle included in the ionizer 323 to generate corona discharge to remove charge using ions generated by the corona discharge. In this manner, by the charge removal roller 322 performing rough charge removal and the ionizer 323 adjusting the residual charge, a sheet 707 that is subjected to the charge removal processing and ejected from the charge removal apparatus 200-3a is in a state where the charge is neutralized.

The charge removal processing described above is merely an example, and is not limited thereto.

The description will be given again with reference to the cross-sectional view of FIG. 3.

The charge removal apparatus 200-3a includes the charge removal roller 322 and its paired roller. The sheet conveyed to the charge removal apparatus 200-3a is conveyed while being nipped between the charge removal roller 322 and the paired roller to be subjected to the above-described rough charge removal by the charge removal roller 322. The ionizer 323 then performs the charge removal processing on the residual charge while the sheet is being conveyed by a conveyance roller 324 to the outside of the charge removal apparatus 200-3a.

### Saddle-Stitch Binding Device

The saddle-stitch binding device 200-3b will now be described.

Examples of the sheet processing performed by the saddle-stitch binding device 200-3b include saddle-stitch binding, punching processing, cutting processing, shift output processing, folding processing, and stapling processing. In the present embodiment, these types of jobs are collectively referred to as a “saddle-stitch binding job”.

To process a saddle-stitch binding job, first, the CPU 205 causes the saddle-stitch binding device 200-3b to convey the sheets subjected to printing by the printing device 100 and perform the sheet processing on the sheets for the job. The CPU 205 then causes a corresponding sheet ejection destination portion Z of the saddle-stitch binding device 200-3b to hold the printed products of the saddle-stitch binding job, which is subjected to the sheet processing performed by the saddle-stitch binding device 200-3b. In addition, as a sheet ejection destination Z, there is a plurality of sheet ejection destination candidates. This is why the saddle-stitch binding device 200-3b can perform a plurality of types of sheet processing, and each of the sheet ejection destination portions is used when sheets are each sorted to the corresponding sheet ejection destination portion every time the sheet processing is performed. In the present embodiment, a detailed conveyance procedure of the saddle-stitch binding job will be omitted.

### Printing Processing

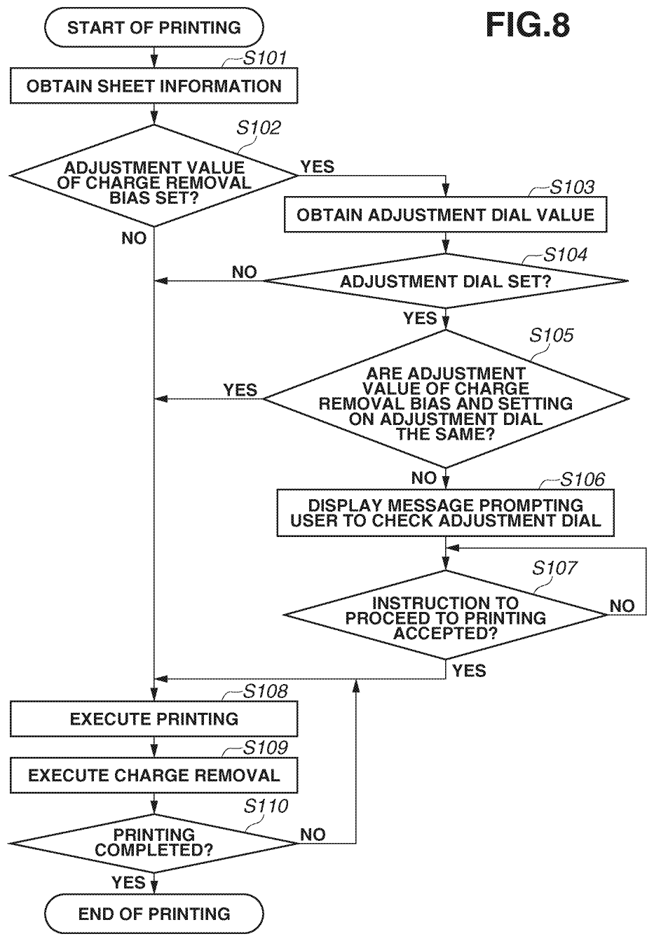

FIG. 8 is a flowchart of the printing processing in the first embodiment. The processing of this flowchart is performed by the CPU 205 loading a program from the ROM 207, HDD 209, or the like, into the RAM 208 to execute the program. The processing starts when a print job is submitted to the printing system 1000.

In step S101 at the start of the printing processing, the CPU 205 of the printing device 100 interprets the settings of the submitted print job and selects the optimal sheet feed unit to obtain the sheet type to be used for printing. Further, the CPU 205 obtains the adjustment value of the charge removal bias set for the sheets via the sheet data management unit 211.

In step S102, the CPU 205 of the printing device 100 determines whether the adjustment value of the charge removal bias obtained in step S101 is set. If the CPU 205 determines that the adjustment value of the charge removal bias is set for the sheet (YES in step S102), the processing proceeds to step S103. If the CPU 205 determines that the adjustment value of the charge removal bias is not set for the sheet, i.e., the adjustment value of the charge removal bias is zero (NO in step S102), the processing proceeds to step S108.

### If Adjustment Value of Charge Removal Bias is Set

In step S103, the CPU 205 obtains the setting value of the amount of charge removal of the charge removal apparatus 200-3a. This operation is performed by the CPU 205 obtaining the setting state of the adjustment dial 602 of the charge removal operation unit 220 via the charge removal apparatus 200-3a.

In step S104, the CPU 205 of the printing device 100 determines whether the amount of charge removal on the adjustment dial 602 obtained in step S103 is set. If the adjustment dial 602 is set (YES in step S104), the processing proceeds to step S105. If the adjustment dial 602 is not set, i.e., if the setting on the adjustment dial is zero (NO in step S104), the processing proceeds to step S108. In this case, the charge removal processing is performed based on the adjustment value of the charge removal bias obtained from the sheet data management unit 211 in step S101.

In step S105, the adjustment value of the charge removal bias obtained in step S101 set for the sheet is compared with the setting on the adjustment dial obtained in step S103 to determine whether the values are the same. If the values are the same (YES in step S105), steps S106 and S107 described below are skipped and the processing proceeds to step S108.

In this manner, if the values are the same, steps S106 and S107 described below are skipped to avoid prompting the user to unnecessarily check the setting value. On the other hand, if the values are different (NO in step S105), the processing proceeds to step S106.

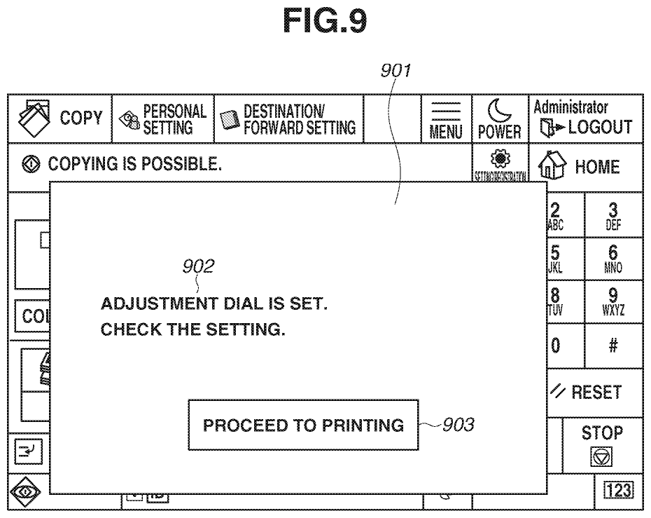

In step S106, the CPU 205 of the printing device 100 displays a print start check screen 901 as illustrated in FIG. 9 on the main body operation unit 204 of the printing device 100 to notify the user that the setting value of the charge removal apparatus 200-3a needs to be checked.

### Print Start Check Screen

FIG. 9 is a diagram illustrating an example of the print start check screen 901.

On the print start check screen 901, the CPU 205 of the printing device 100 displays a message 902 to inform the user that the adjustment dial of the charge removal apparatus 200-3a needs to be checked and to prompt the user to check whether the printing processing is to be resumed.

The user checks the setting on the adjustment dial 602 of the charge removal apparatus 200-3a, and if the user wishes to resume printing after changing the setting as appropriate, the user presses a proceed-to-printing button 903. Via such a screen, the printing system 1000 allows the user to check the setting on the adjustment dial 602 of the charge removal apparatus 200-3a.

In step S107, the CPU 205 of the printing device 100 determines whether the proceed-to-printing button 903 is pressed on the print start check screen 901 illustrated in FIG. 9. If the CPU 205 determines that the proceed-to-printing button 903 is not pressed (NO in step S107), the CPU 205 waits until the button is pressed.

On the other hand, if the CPU 205 determines that the proceed-to-printing button 903 is pressed (YES in step S107), the processing proceeds to step S108.

In step S108, the CPU 205 of the printing device 100 resumes the printing processing based on the instruction to start printing, performing printing.

In step S109, the CPU 205 of the printing device 100 executes charge removal processing on the sheet subjected to printing based on the settings of the charge removal operation unit 220. If the process has reached step S109 through step S107, the adjustment value of the charge removal bias and the setting on the adjustment dial are different. In this case, the CPU 205 instructs the charge removal apparatus 200-3a to set the setting value on the adjustment dial 602 as the bias value of the charge removal roller 322, and the processing proceeds to step S110.

In step S110, the CPU 205 of the printing device 100 determines whether the print job is completed. If the print job is not completed (NO in step S110), the process returns to step S108.

On the other hand, if the print job is completed (YES in step S110), the processing of the flowchart ends.

### Second Embodiment

In the first embodiment, the processing is described of displaying the message 902 prompting the user to check the adjustment dial 602 of the charge removal apparatus 200-3a at the time of execution of printing processing. In a second embodiment, a method will be described for checking when the adjustment value on a charge removal bias is changed separately from the printing processing. Processing in the second embodiment will now be described.

### Printing Processing

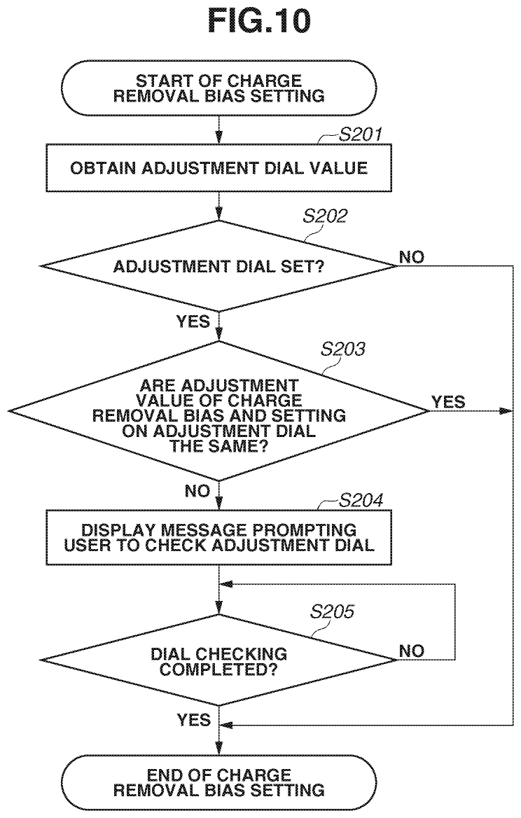

FIG. 10 is a flowchart for describing processing for prompting the user to check a charge removal apparatus setting value in the second embodiment. The processing of this flowchart is performed by a CPU 205 loading a program from a ROM 207, an HDD 209, or the like into a RAM 208 to execute the program. This operation is started by the CPU 205 of a printing device 100 in response to the user pressing a change button 803 in a parameter list screen 801 on a touch panel unit 401 and then adjusting the charge removal bias. Specifically, when the user presses the change button 803, a charge removal bias adjustment screen 804 illustrated in FIG. 7B is displayed. The user operates input buttons 806 to change a current charge removal bias adjustment value 805. Then, the processing is performed if the CPU 205 determines that an OK button 807 is pressed. If a cancel button 808 is pressed, this processing is not performed.

In step S201, the CPU 205 obtains the setting value of the amount of charge removal of a charge removal apparatus 200-3a. This operation is performed by the CPU 205 obtaining the setting state of an adjustment dial 602 of a charge removal operation unit 220 via the charge removal apparatus 200-3a.

In step S202, the CPU 205 of the printing device 100 determines whether the setting value of the adjustment dial obtained in step S201 is set. If the setting value on the adjustment dial is set (YES in step S202), the processing proceeds to step S203. If the setting value on the adjustment dial is not set, i.e., if the adjustment dial is set to zero (NO in step S202), the processing of the flowchart ends.

In step S203, the adjustment value of the charge removal bias set for the sheet is compared with the setting on the adjustment dial acquired in step S201 to determine whether the values are the same. The adjustment value of the charge removal bias set for the sheet is obtained by the CPU 205 referring to the charge removal bias adjustment value saved in the RAM 208 as described above with reference to FIG. 7B.

If the values are the same (YES in step S203), steps S204 and S205 described below are skipped and the process ends. In this manner, the values being the same causes steps S204 and S205 described below to be skipped, avoiding prompting the user to unnecessarily check.

In this case, the adjustment value of the charge removal bias is prioritized as the setting value.

On the other hand, if the values are different (NO in step S203), the processing proceeds to step S204.

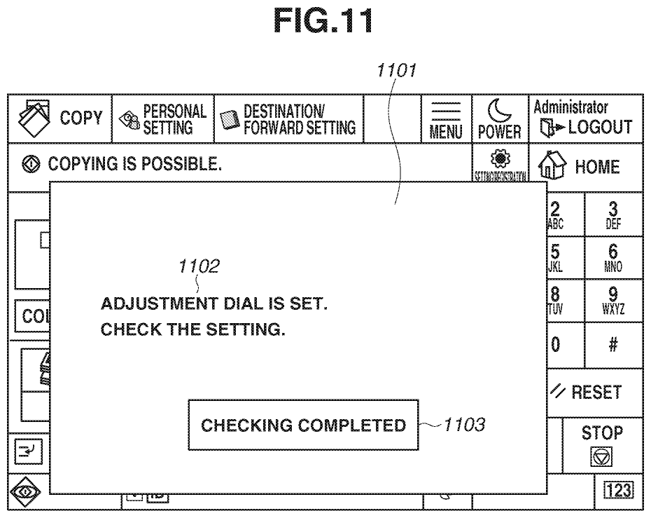

In step S204, the CPU 205 of the printing device 100 displays a check screen 1101 for the setting values of the charge removal apparatus 200-3a as illustrated in FIG. 11 on a main body operation unit 204 of the printing device 100, and notifies the user that the setting value of the charge removal apparatus 200-3a needs to be checked.

### Charge Removal Apparatus Setting Value Check Screen

FIG. 11 is a diagram illustrating an example of the check screen 1101 for the setting value of the charge removal apparatus 200-3a.

On the check screen 1101 for the setting value of the charge removal apparatus 200-3a, the CPU 205 of the printing device 100 displays a message 1102 to inform the user that the adjustment dial of the charge removal apparatus 200-3a needs to be checked, and issues a notification prompting the user to check the setting value of the charge removal apparatus 200-3a.

The user checks the setting on the adjustment dial 602 of the charge removal apparatus 200-3a, and if the user completes the check of the setting value of the charge removal apparatus 200-3a after the setting is changed as appropriate, the user presses a checking-completed button 1103. Via such a screen, a printing system 1000 allows the user to check the setting on the adjustment dial of the charge removal apparatus 200-3a.

In step S205, the CPU 205 of the printing device 100 determines whether the checking-completed button 1103 is pressed on the check screen 1101 for the charge removal apparatus setting value illustrated in FIG. 11. If the CPU 205 determines that the checking-completed button 1103 is not pressed (NO in step S205), the CPU 205 waits until the button is pressed.

On the other hand, if the CPU 205 determines that the checking-completed button 1103 is pressed (YES in step S205), the processing of the flowchart ends. Here, the user changes the setting value on the adjustment dial 602 to zero in response to the message 1102 displayed in step S204, i.e., the user can change to a state in which no setting is configured on the adjustment dial 602. In this case, the setting value on the charge removal bias adjustment screen 804 is prioritized. The CPU 205 then instructs the charge removal apparatus 200-3a to set the charge removal bias adjustment value 805 on the charge removal bias adjustment screen 804 in FIG. 7B as the bias value of charge removal roller 322.

On the other hand, if the setting value on the adjustment dial 602 is not set to zero, i.e., if the adjustment dial 602 is set, the CPU 205 instructs the charge removal apparatus 200-3a to set the setting value on the adjustment dial 602 as the bias value of the charge removal roller 322.

Subsequently, in response to submission of a print job to the printing system 1000, the CPU 205 performs the charge removal processing on the sheets subjected to printing processing using the charge removal bias value the CPU has instructed the charge removal apparatus 200-3a to set.

### Other Embodiments

Further, the configurations and the details of the various types of data described above are not limited to the above description, and it goes without saying that the various types of configurations and details may be used depending on the usage and the purpose.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-070476, which was filed on Apr. 22, 2025 and which is hereby incorporated by reference herein in its entirety.

What is claimed is:

1. A printing system comprising:
a charge removal apparatus;
at least one memory that stores instructions; and
at least one processor that causes, by performing the stored instructions, the printing system to:
set a first setting value of a first amount of charge removal for a sheet in a storage unit configured to store a setting value of an amount of charge removal for each sheet type;
obtain a second setting value of a second amount of charge removal set via an operation unit of the charge removal apparatus; and
notify a user of information that prompts the user to check a charge removal setting set via the operation unit, in a case where, when the first amount of charge removal is set in the storage unit, the first setting value of the first amount of charge removal is different from the second setting value of the second amount of charge removal.

2. The printing system according to claim 1, wherein the at least one processor causes the printing system not to, in a case where the first setting value of the first amount of charge removal and the second setting value of the second amount of charge removal are the same, notify the user of the information when the first amount of charge removal is set in the storage unit.

3. The printing system according to claim 2, wherein the at least one processor causes the printing system to, in the case where the first setting value of the first amount of charge removal and the second setting value of the second amount of charge removal are the same, prioritize the first setting value of the first amount of charge removal.

4. The printing system according to claim 1, wherein the at least one processor causes the printing system to, in a case where the second setting value of the second amount of charge removal is zero, set the first setting value of the first amount of charge removal as a setting value of an amount of charge removal for a sheet on which an image is printed without notifying the user of the information.

5. The printing system according to claim 1, wherein the at least one processor causes the printing system to, in a case where the information is checked by the user, set the second setting value of the second amount of charge removal as a setting value of an amount of charge removal for a sheet on which an image is printed.

6. A control method for a printing system including a charge removal apparatus, the control method comprising:
setting, as a first setting, a first setting value of a first amount of charge removal for a sheet in a storage unit configured to store a setting value of an amount of charge removal for each sheet type;
obtaining, as a second setting, a second setting value of a second amount of charge removal set via an operation unit of the charge removal apparatus; and
notifying a user of information that prompts the user to check a charge removal setting set via the operation unit, in a case where, when the first amount of charge removal is set in the storage unit in the first setting, the first setting value of the first amount of charge removal is different from the second setting value of the second amount of charge removal set in the second setting.

7. A non-transitory computer-readable storage medium storing a program to cause a computer to execute a control method for a printing system including a charge removal apparatus, the control method comprising:
setting, as a first setting, a first setting value of a first amount of charge removal for a sheet in a storage unit configured to store a setting value of an amount of charge removal for each sheet type;
obtaining, as a second setting, a second setting value of a second amount of charge removal set via an operation unit of the charge removal apparatus; and
notifying a user of information that prompts the user to check a charge removal setting set via the operation unit, in a case where, when the first amount of charge removal is set in the storage unit in the first setting, the first setting value of the first amount of charge removal is different from the second setting value of the second amount of charge removal set in the second setting.
